(19) United States
(12) Patent Application Publication
(10) Pub. No.: US 2007/0162470 A1
(43) Pub. Date: Jul. 12, 2007

(54) Method and apparatus for event transformation and adaptive correlation for monitoring business solutions

(75) Inventors: Hung-yang Chang, Scarsdale, NY (US); Shyh-Kwei Chen, Chappaqua, NY (US); Jun-Jang Jeng, Armonk, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/329,210

(22) Filed: Jan. 10, 2006

(51) Int. Cl. G06F 7/00

(52) U.S. Cl. 707/100

(57) ABSTRACT

A method and apparatus are disclosed for correlating structured event data, comprising the steps of selecting aggregation elements and creating a structured template utilizing the selected aggregation elements. The structured event data is then translated to name-value pair sets based on the structured template. In one exemplary embodiment, the structured template is created by searching the structured event data for repeatable node-value pairs. In one aspect of the invention, a region tree is created, wherein intermediate nodes represent shared fragments, leaf nodes represent regions, and wherein regions are a unique set of nodes whose sub-tree can have multiple occurrences. In another aspect of the invention, the translation of the structured event data comprises the steps of parsing the structured event data in depth first search order; and forming regions based on an aggregation element set. The translation may also require the steps of obtaining a region tree; selecting one instance from each region; and joining the selected instances to form a target that conforms to a translation rule syntax.

### FIELD OF THE INVENTION

The present invention relates to the field of event correlation, and more particularly, to methods and apparatus for correlating events in a structured format using legacy-based event correlation engines.

### BACKGROUND OF THE INVENTION

Event correlation is an important component in business performance management. Legacy rule-based event correlation engines, such as the Zurich Correlation Engine (ZCE), typically accept input events that include only name-value pairs. (For a detailed description of the ZCE, see, “The Role of Ontologies in Autonomic Computing Systems,” IBM Systems Journal, Vol. 43, No. 3, 2004, pp 598-616; and U.S. Pat. No. 6,336,139.) The name-value pairs in a single input event should have unique names within each set of name-value pairs in order for the names to serve as keys to a hash table that is used to store the associated values. While legacy correlation engines can offer great expressive power for advanced actions like aggregation and filtering, they are not capable of performing event correlation on data in a structured format.

At first glance, it would appear that correlating events in a structured format (such as the Extensible Markup Language (XML)) using legacy rule-based event correlation engines is trivial. For example, the whole structured event could be treated as a value associated with a new name, thereby creating a single name-value pair. This approach, however, has a number of disadvantages. First, the entire event would need to go through a service bus (a pattern of middleware that unifies and connects services, applications, and resources), wherein only a small portion of the event may be relevant. Second, in order to fit into the name-value format, the entire event message may need to be converted by an escaping process for special characters at the event producer side and an un-escaping process at the correlation engine side, as is well known in the art. Third, users cannot take advantage of the expressive power of the rule syntax and may need to code the aggregation and filtering operations in the action sessions of the correlation engines. Finally, the correlation engine may be required to parse the XML event(s) in their entirety.

A need, therefore, exists for a method and apparatus to preprocess the structured events, and decompose them into sets of name-value pairs, with distinct names within each set, in order for the structured events to be processed by legacy correlation engines.

### SUMMARY OF THE INVENTION

Generally, a method and apparatus are disclosed to preprocess structured events to create unique name-value pairs that can be correlated by legacy event correlation engines. The first step is to treat each element or attribute tag as a name and its corresponding content as a value while preserving the event structural relations among the elements and attributes. Distinct names are utilized for each set to avoid confusion for the correlation engine and simplify the rule action coding. In one exemplary embodiment, the structured event utilizes an XML format and may include the following constructs:
1. Repetitive children elements resulting in multiple sibling elements with the same tags;
2. Same attribute name with element name; and
3. Element name recursively shows up on the same path.

The present invention decomposes the structured event that can best utilize the expressive power of the rule syntax offered by the correlation engines. The method is model driven, is easy to configure, and is implemented as a middleware object that maps a single XML event into multiple similar smaller events for the correlation engine to process. With the addition of a simple rule syntax, legacy correlation engines can offer great expressive power for advanced actions like aggregation and filtering with limited coding effort.

More specifically, an exemplary method for correlating structured event data comprises the steps of selecting aggregation elements and creating a structured template utilizing the selected aggregation elements. The structured event data is then translated to name-value pair sets based on the structured template. In one exemplary embodiment, the structured template is created by searching the structured event data for repeatable node-value pairs. In one aspect of the invention, a region tree is created, wherein intermediate nodes represent shared fragments, leaf nodes represent regions, and wherein regions are a unique set of nodes whose sub-tree can have multiple occurrences. In another aspect of the invention, the translation of the structured event data comprises the steps of parsing the structured event data in depth first search order; and forming regions based on an aggregation element set. The translation may also require the steps of obtaining a region tree; selecting one instance from each region; and joining the selected instances to form a target that conforms to a translation rule syntax.

In another aspect of the present invention, a method to generate event translation style sheets based on one or more region trees is disclosed, comprising the steps of parsing one or more region trees; forming a filtering script that conforms to a style sheet grammar, wherein the forming step is performed for each aggregation node in the one or more region trees; and collecting said filtering script for event translation. Similarly, a method to generate rule sessions based on one or more region trees is disclosed, comprising the steps of parsing one or more region trees; forming a partial rule template that conforms to a rule grammar, wherein the forming step is performed for every aggregation node in the one or more region trees; and collecting the partial rule template for event translation. Finally, a method to generate a region tree is disclosed, comprising the steps of selecting a node from an aggregation set; traversing each branch of an event schema graph in a depth first search order, wherein the traversal on a branch is halted whenever a selection aggregation element is encountered; and adding a new region node to the region tree to represent visited nodes.

A more complete understanding of the present invention, as well as further features and advantages of the present invention, will be obtained by reference to the following detailed description and drawings.

### BRIEF DESCRIPTION OF THE DRAWING

FIG. 1 is a block diagram of an exemplary conventional event correlation system for business performance management;

FIG. 2 is an exemplary tree representation of an input event in a structured format;

FIG. 3 is a block diagram of an exemplary conventional event correlation system for business performance management that incorporates features of the present invention;

FIG. 4 illustrates an exemplary XML schema for parsing and decomposing XML events;

FIG. 5 illustrates exemplary regions for the exemplary input event of FIG. 2;

FIG. 6 illustrates an exemplary region tree for the exemplary input event of FIG. 2;

FIGS. 7-9 illustrate exemplary input events in a structured (tree) format with the associated name-value pair translation;

FIG. 10 is a flowchart of a second exemplary event correlation system that incorporates features of the present invention;

FIG. 11 is a flowchart of an exemplary region tree creation algorithm;

FIG. 12 is a flowchart of an exemplary script/template generation algorithm;

FIG. 13 is a flowchart of an exemplary translation method;

FIG. 14 is a flowchart of an exemplary XML tree join method;

FIG. 15 is a flowchart of an exemplary method to name elements and attributes in a structured XML event; and

FIG. 16 is a block diagram of a Run-Time Event Correlation system 1600.

### DETAILED DESCRIPTION

The present invention provides methods and apparatus to preprocess the structured events, and decompose them into sets of name-value pairs, with distinct names within each set, in order for the structured events to be processed by legacy correlation engines.

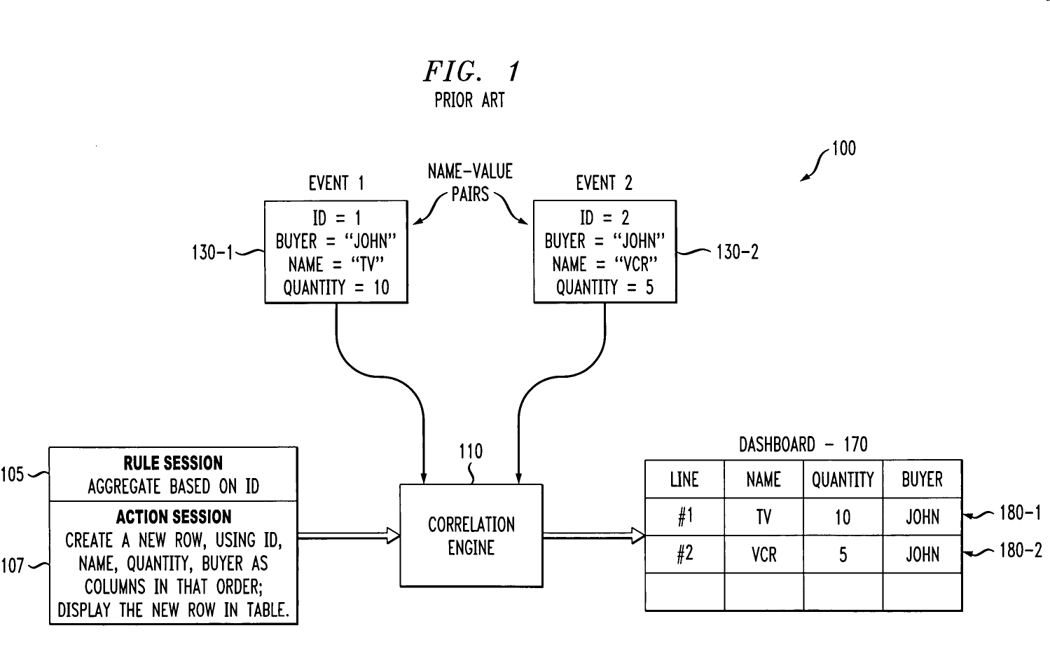

FIG. 1 is a block diagram of an exemplary conventional event correlation system 100 for business performance management. The event correlation system 100 accepts input events, such as Event-1 130-1 and Event-2 130-2 (collectively known as input events 130 hereinafter) that are each composed of name-value pairs, including the following names: ID (an event identifier), buyer (a buyer), name (the name of an item), and quantity (the quantity of the associated item). The event correlation system 100 comprises an event correlation engine 110 that accepts input events 130 in name-value pair format, e.g. Event-1 and Event 2. (Event correlation system 100 cannot, however, process data that is in a structured format, e.g., XML.) A rule session 105 contains rules instructing the correlation engine 110 on how to correlate the input events 130. For example, an exemplary rule instructs the correlation engine 110 to aggregate events based on the ID. The action session 107 contains information (e.g., instruction(s)) describing how the correlation engine 100 should format the correlated output data via Dashboard 170. An exemplary instruction may instruct the correlation engine 110 to create a new entry using the ID, name, quantity, and buyer as fields in that order, and to display the new entry 180-2 in the output table of Dashboard 170. In another exemplary embodiment (not shown), input events 130 that contain matching name-value pairs may be displayed in a single entry with one field indicating the number of input events 130 that have the associated values. It should be noted that the conventional systems, e.g., exemplary conventional event correlation system 100, require a user to write the rules of rule session 105 and the instructions of action session 107 based on a name-value pair format.

In the exemplary conventional event correlation system 100, an entire complex/structured event is treated as a value of a new name. Thus, the entire event goes through the service bus, the entire event message may need to be converted by an escaping process for special characters at the event producer side and an un-escaping process at the correlation engine side, and the entire complex event may need to be parsed by the correlation engine.

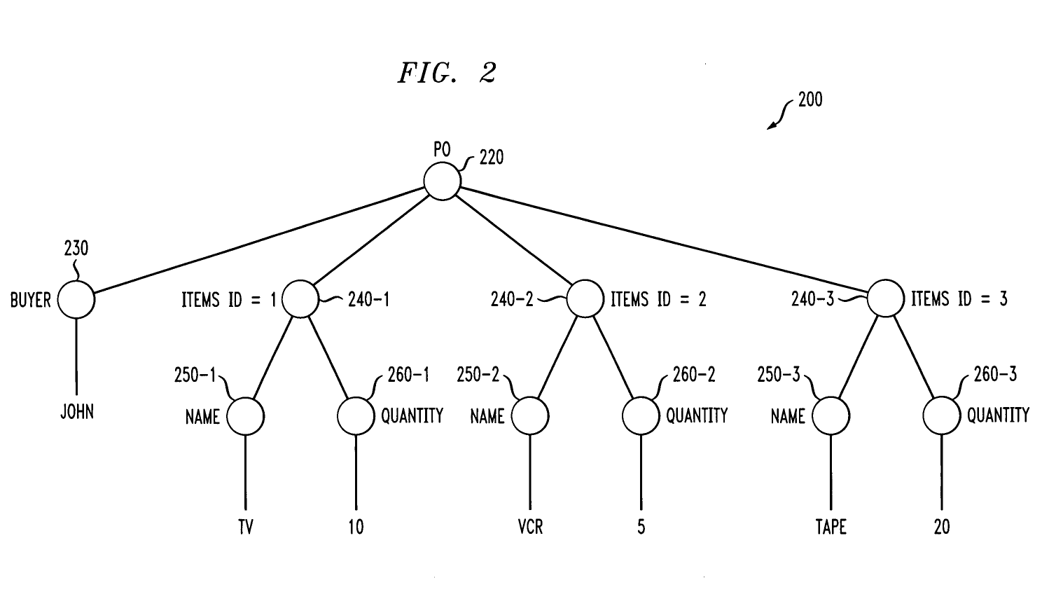

FIG. 2 is a tree diagram of an exemplary input event 200 for a purchase order (PO) in a structured format (XML). A typical PO input event 200 has a single buyer node 230 and one or more items nodes 240. The root node 220 represents an instance of one purchase order and, as illustrated, has four children: a buyer node 230 and items nodes 240-1, 240-2, 240-3 (collectively known as items nodes 240 hereinafter). The buyer node 230 has a single leaf node representing the buyer, John. The items nodes 240 each have two children: name nodes 250-1, 250-2, 250-3 and quantity nodes 260-1, 260-2, 260-3. Each name node 250-1, 250-2, 250-3 has a leaf node representing the name of the associated item and each quantity node 260-1, 260-2, 260-3 has a leaf node representing the quantity of the associated item. The methods of the present invention map the single XML event 200 into multiple similar smaller events that the correlation engine 110 is capable of processing, i.e., creates unique name-value pairs that can be correlated by legacy event correlation engines.

As noted above, the first step in translating the structured XML event 200 is to treat each element or attribute tag as a name and its corresponding content as a value (i.e., create the name-value pairs) while preserving the event structured relations among the elements and attributes by using name-value pairs. Also, as noted above, some children within the input event tree may repeat (e.g., items 240) and, thus, care must be taken when cutting the tree (to create smaller similar events) that ensure that the name-value pairs are unique within each set, thus avoiding confusion for the correlation engine and simplifying the rule action coding.

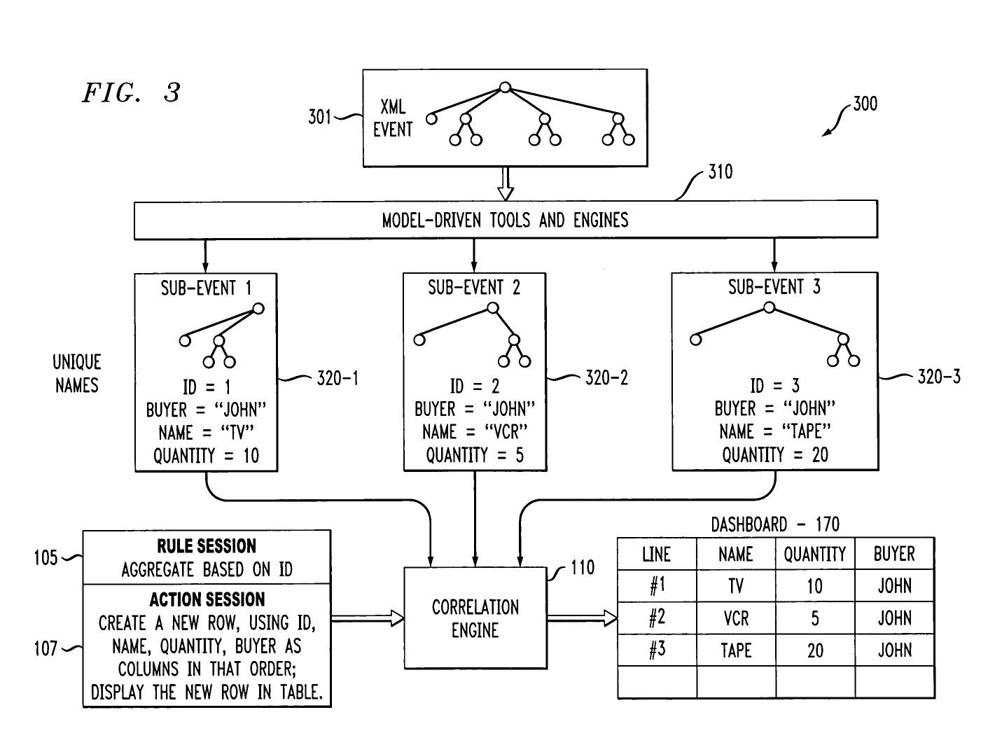

FIG. 3 is a block diagram of an exemplary conventional event correlation system 300 for business performance management that incorporates features of the present invention. The input to the event correlation system 300 is a complex/structured event 301 in an XML format. The novel model-driven tools and engines component 310 creates sub-events 320-1, 320-2, 320-3, each of which contains unique names, from the complex/structured input event 301. The sub-trees of sub-events 320-1, 320-2, 320-3 are created according to a predefined schema that indicates an acceptable structure for the sub-tree. The name-value pairs of sub-events 320-1, 320-2, 320-3 are then created directly from the associated sub-trees. In addition, model-driven tools and engines component 310 creates rules for the rule session 105 based on the user-selected aggregation element set. Correlation engine 110 and dashboard 170 are conventional components, as described above.

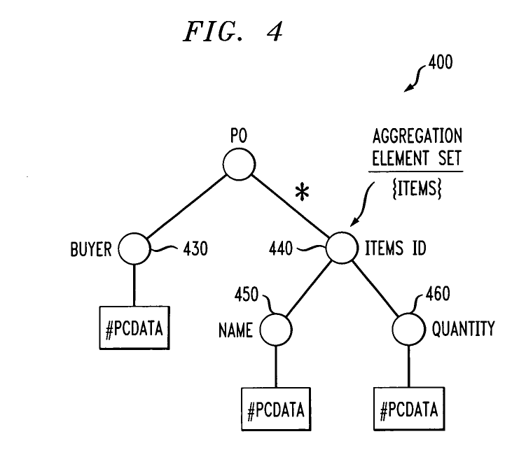

During run-time, an XML input event 301 is parsed and decomposed into smaller XML sub-events 320-1, 320-2, 320-3 with possible overlapping elements, based on selected aggregation elements, as defined in an XML schema. For example, FIG. 4 illustrates an XML schema 400 for parsing and decomposing XML input events 301, where the aggregation element set is based on the items node 440 since the items nodes 440 are repeatable within the complex/structured input event 301. In one exemplary embodiment, the XML schema 400 is initially specified by the user or from standards, e.g., those from cXML, RosettaNet, and Common Business Logic xCBL. The selected aggregation elements thus determine where the complex/structured input event 301 tree is to be cut. The correlation engine 110 is then configured to process XML input event 301 utilizing the exemplary XML schema 400. It is noted that the notation “*” in FIG. 4 illustrates children within the input event tree that repeat.

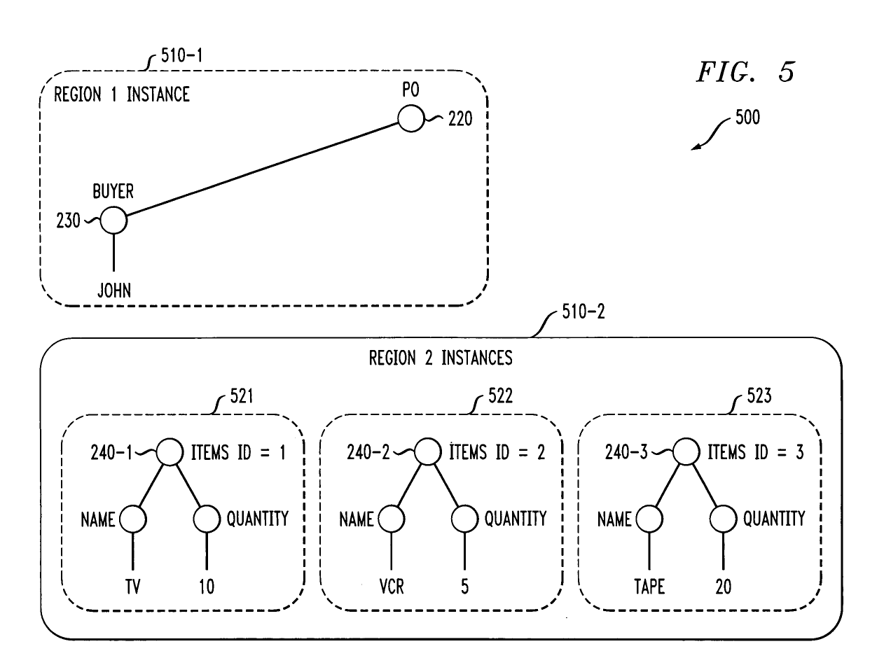

FIG. 5 illustrates exemplary region instances 510-1, 510-2 for the exemplary input event 200 of FIG. 2 that are used to preserve the event structured relations among the elements and attributes that would be lost when the sub-trees are created. Based on the XML schema, the set of aggregation elements forms a region tree that can essentially be used to divide the XML input event 301 into multiple region instances 510-1, 510-2. For a given region instance 510-1, 510-2, a method is provided to identify the unique set of nodes whose sub-tree 521, 522, 523 can have multiple occurrences. In the present example, Region 1 instance 510-1 is composed of the sub-tree of the input event 200 that contains the root node 220 and the buyer node 230. There are three instances of Region 2 instance 510-2, each containing one of the sub-trees 521, 522, 523 whose root has multiple occurrences, e.g., the sub-tree 521 whose root is the items node 240-1.

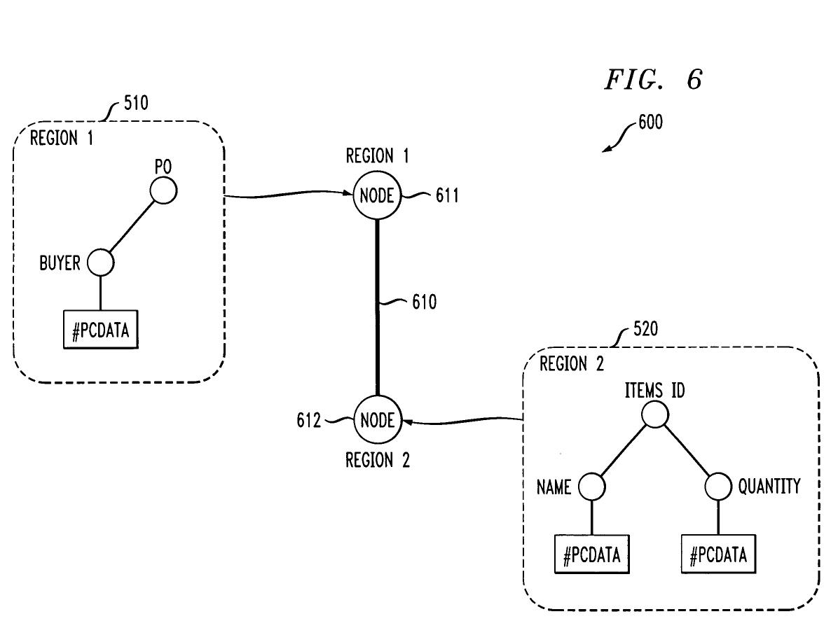

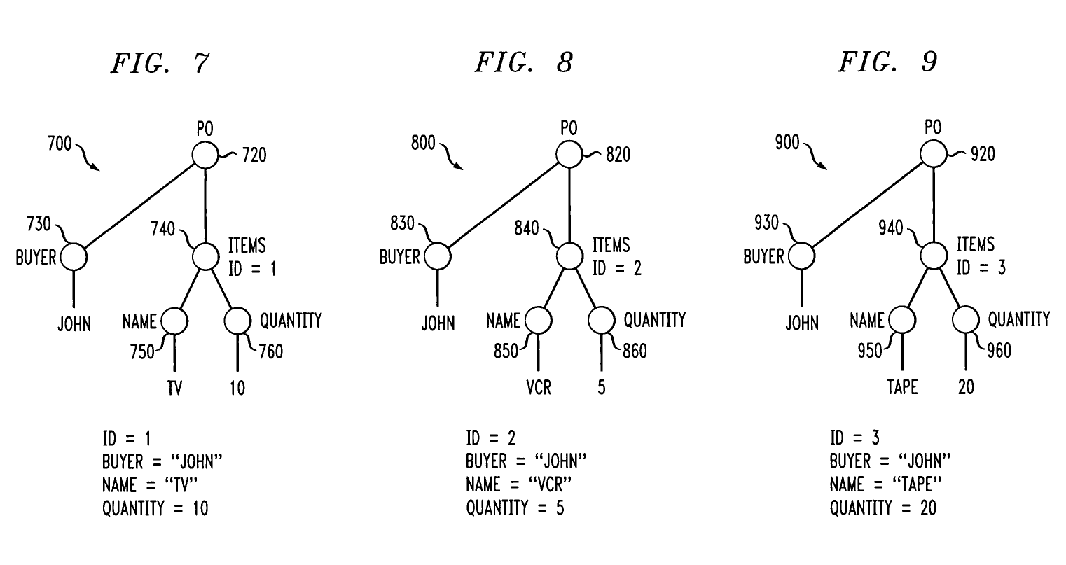

FIG. 6 illustrates an exemplary region tree 610 for the exemplary input event 200 according to the regions 510, 520 defined in FIG. 5. The region tree 610 comprises leaf nodes 611, 612 that represent regions 510, 520, respectively. In alternative region trees (not shown), intermediate nodes represent shared fragments. As illustrated in FIG. 6, the region tree shows that region 1 510 is connected to region 2 520, thus preserving the event structured relations of input event 200. (Note that nodes 510-1 and 510-2 in FIG. 5 represent region instance nodes, while nodes 510 and 520 in FIG. 6 represent region nodes in a region tree, which represent schema elements, not instances.) FIGS. 7-9 illustrate three exemplary input events 700, 800, 900 in a structured (tree) format that correspond to the translated sub-trees of input event 200. The methods of the present invention convert the complex structured input event 200 into the smaller input events 700, 800, 900 that can be processed by legacy correlation engine 110, while preserving the event structural relations among the elements and attributes using name-value pairs. Input events 700, 800, 900 can easily be converted to events in a name-value pair format that can be processed by legacy correlation engine 110. (The converted name-value pairs are illustrated below the associated sub-tree in FIGS. 7-9.) Each root node 720, 820, 920 represents an instance of a purchase order and has two children: a buyer node 730, 830, 930 and items node 740, 840, 940. Each buyer node 730, 830, 930 has a single leaf node representing the same buyer, John. Each items node 740, 840, 940 has two children: a name node 750, 850, 950 and quantity node 760, 860, 960. Each name node 750, 850, 950 has a leaf node representing the name of the associated item and each quantity node 760, 860, 960 has a leaf node representing the quantity of the associated item.

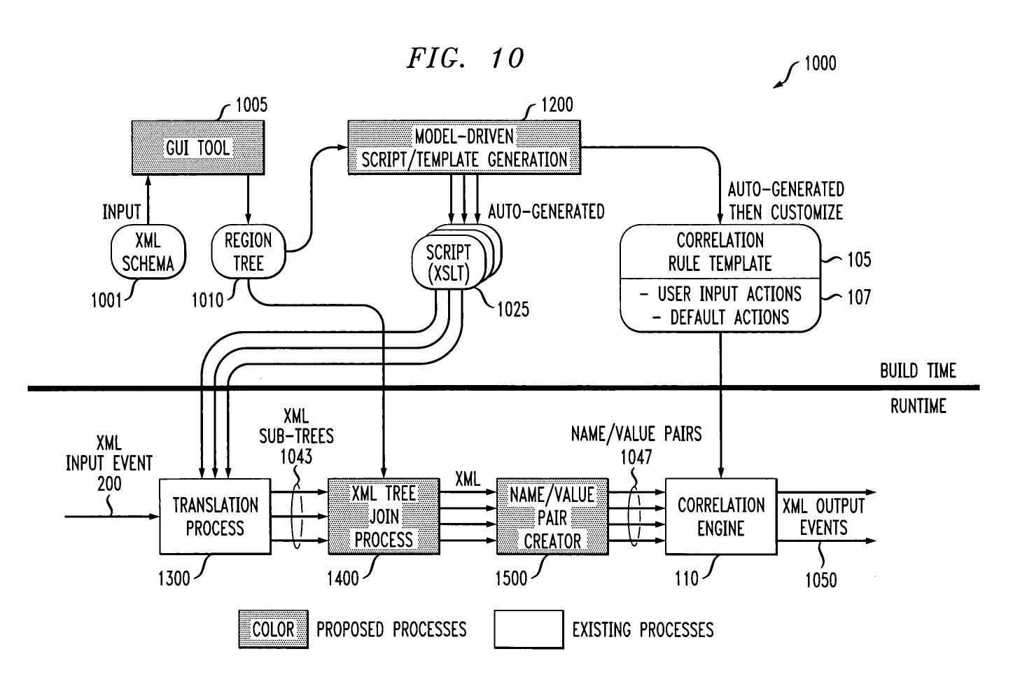

FIG. 10 is a block diagram of an alternative conventional event correlation system 1000 for business performance management that incorporates features of the present invention. XML Schema 1001 is a structured XML schema (template), such as XML schema 400, for parsing and decomposing XML input events 301. GUI tool 1005 is a graphical user interface that generates a region tree 1010, such as exemplary region tree 600, based on XML schema 1001. Region tree 1010 is utilized by model-driven generator 1200 to generate an XSLT script 1025, and rule session 105. As described above, rule session 105 instructs the correlation engine 110 on how to correlate the XML input events 301. XSLT script 1025 instructs the translation process 1300 on how to convert an XML input event 301, such as XML event 200, into XML sub-trees 1043. Translation process 1300 is well known in the prior art and is beyond the scope of the present invention. XML Tree Join Engine 1400 and Name/Value Pair Creator 1500 convert XML sub-trees 1043 into name-value pairs 1047 that are input to the correlation engine 110. XML output events 1050 are generated by correlation engine 110 and may be displayed, for example, by dashboard 170.

During a build-time of event correlation system 1000, GUI Tool 1005 allows users to select a set of aggregation elements that are repeatable. During run-time, XML input events 301 are parsed and decomposed into smaller XML events with possible overlapping elements, based on the selected aggregation elements. As described above, these smaller events are converted into name/value pairs 1047 and are forwarded to correlation engine 110 for matching and aggregation. The repeatable elements that are not selected as aggregation elements during the build-time may have their contents ignored or concatenated into a value string.

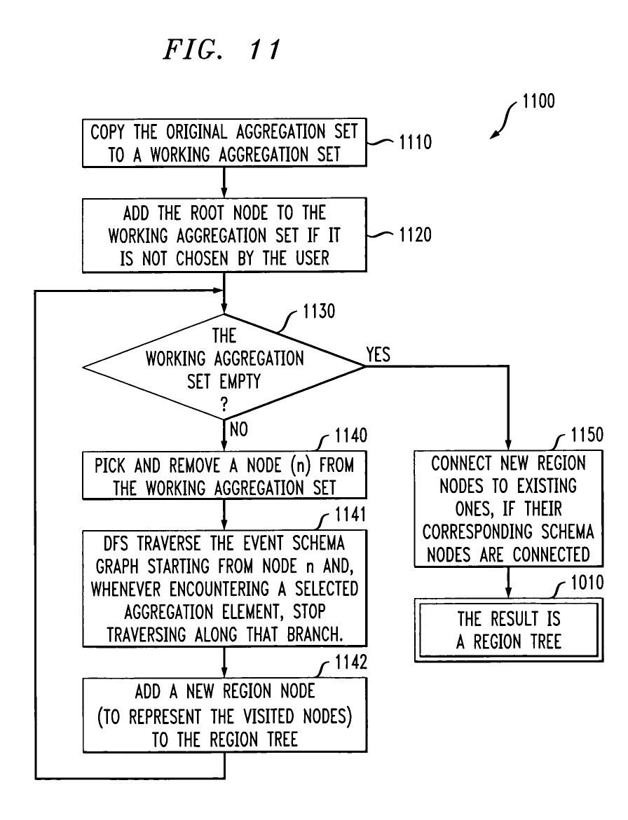

FIG. 11 is a flowchart of an exemplary region tree creation algorithm 1100. During step 1110, the original aggregation set is copied to a working aggregation set. The root node is then added to the working aggregation set if it is not chosen by the user (step 1120). A test is then performed to determine if the working aggregation set is empty (step 1130). If, during step 1130, it is determined that the working aggregation set is empty, then the new region nodes are connected to the existing region nodes by adding directed edges if their corresponding schema nodes are connected (step 1150). The result is a region tree 1010. If, during step 1130, it is determined that the working aggregation set is not empty, then a node n is selected and removed from the working aggregation set (step 1140). The event schema graph is then traversed in depth first search order starting from node n and, whenever a selected aggregation element is encountered, the traversing along the associated branch is stopped (step 1141). A new region node that represents the nodes visited during step 1141 is then added to the region tree (step 1142), and the method repeats step 1130.

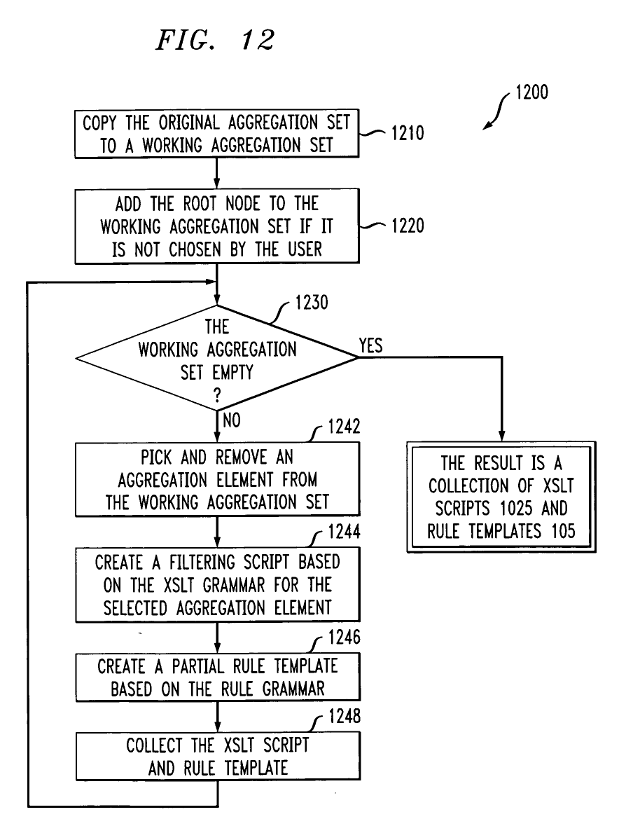

FIG. 12 is a flowchart of an exemplary script/template generation method 1200 incorporating features of the present invention. During step 1210, the original aggregation set is copied to a working aggregation set. The root node is then added to the working aggregation set if it is not chosen by the user (step 1220). A test is then performed to determine if the working aggregation set is empty (step 1230). If, during step 1230, it is determined that the working aggregation set is empty, then the method halts execution and the result is a collection of XSLT scripts (1025) and rule templates (105). If, during step 1230, it is determined that the working aggregation set is not empty, then a node n is selected and removed from the working aggregation set (step 1242). A filtering script based on the XSLT grammar is created for the selected aggregation element (e.g., the matching template in the XSLT script includes a simple Xpath leading to the aggregation element; step 1244). A partial rule template based on the rule grammar is then created (e.g., the rule template may include just the aggregation element name for ZCE; step 1246). The XSLT script 1025 and rule template 105 are then collected (one script/rule template per aggregation element; step 1248), and the method repeats step 1230.

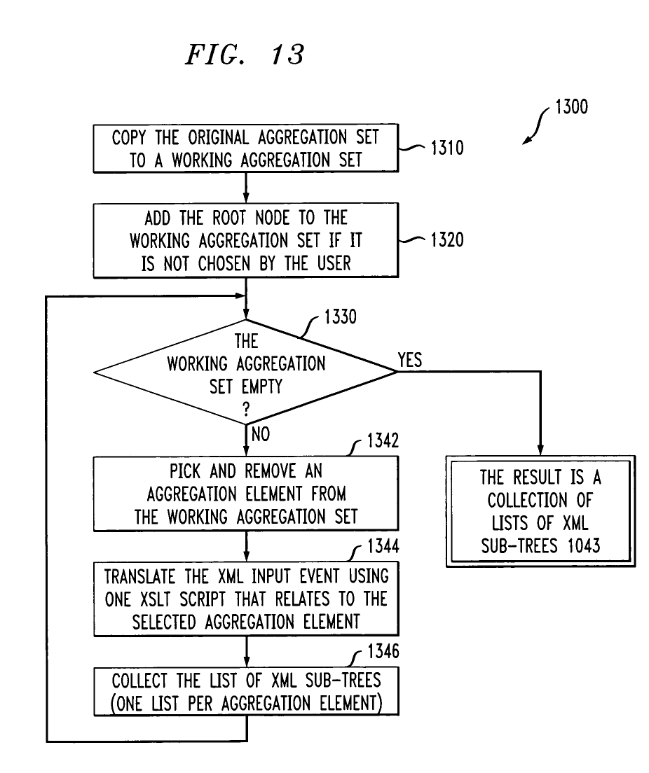

FIG. 13 is a flowchart of an exemplary translation process 1300. During step 1310, the original aggregation set is copied to a working aggregation set. The root node is then added to the working aggregation set if it is not chosen by the user (step 1320). A test is then performed to determine if the working aggregation set is empty (step 1330). If, during step 1330, it is determined that the working aggregation set is empty, then the execution of the method is halted and the result is a collection of lists of XML sub-trees, where one list includes multiple XML sub-trees with the same aggregation element (1043). If, during step 1330, it is determined that the working aggregation set is not empty, then an aggregation element is selected and removed from the working aggregation set (step 1342). The XML input event 301 is translated using one XSLT script 1025 that relates to the selected aggregation element (step 1344). The list of XML sub-trees is then collected (one list per aggregation element; step 1346) and the method repeats step 1330.

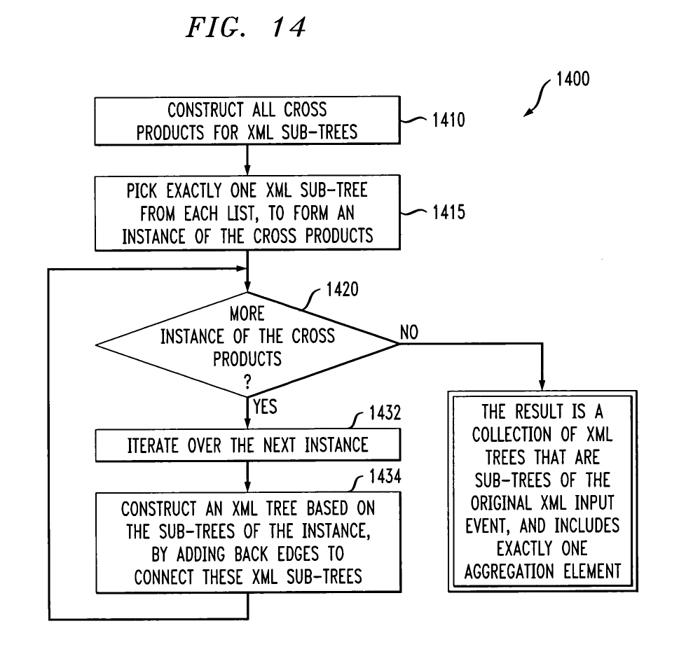

FIG. 14 is a flowchart of an exemplary XML Tree Join process 1400. All cross products for XML sub-trees are constructed during step 1410. Exactly one XML sub-tree from each list is then selected to form an instance of the cross products (step 1415). A test is then performed during step 1420 to determine if there are unprocessed instances of the cross products. If it is determined during step 1420 that there are no unprocessed instances of the cross products, then the method execution is halted and the result is a collection of XML trees that are sub-trees of the original XML input event, and includes exactly one aggregation element. If it is determined during step 1420 that there are unprocessed instances of the cross products, then an iteration is performed over the next instance, where the instance must have the same number of XML sub-trees as the number of aggregation elements plus the root element (step 1432). An XML tree based on the sub-trees of the instance is then created by adding back edges to connect these XML sub-trees (possibly with the help of the region tree) (step 1434). (It should be noted that the added edges must exist in the original XML input event 301.) The method then repeats step 1420.

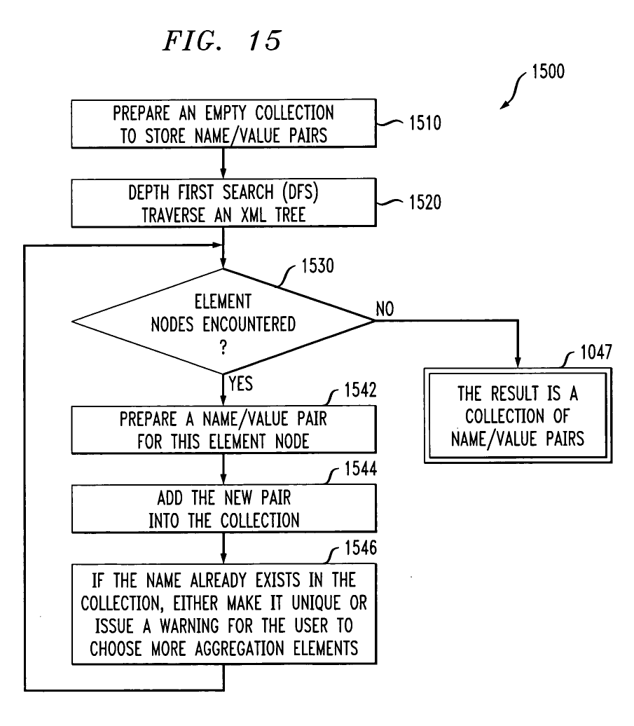

FIG. 15 is a flowchart of an exemplary Name/Value Pair Creator method 1500. An empty collection is prepared in step 1510 to store name/value pairs. An XML tree is then traversed in a Depth First Search order (step 1520). A test is then performed during step 1530 to determine if more element nodes are encountered. If it is determined during step 1530 that no more element nodes were encountered, then the method execution is halted and the result is a collection of name/value pairs 1047. If it is determined during step 1530 that more element nodes were encountered, then a name/value pair for this element node is prepared (step 1542). The new pair is added to the collection (step 1544). A test is then performed during step 1546 to determine if the name already exists in the collection. If it is determined that the name does not exist in the collection, then step 1530 is repeated. If it is determined that the name exists in the collection, then either the name is made unique (for example, by attaching the name with a time-stamp) or a warning is issued for the user to choose more aggregation elements; step 1530 is then repeated.

While FIGS. 11-15 show examples of the sequence of steps, it is also an embodiment of the present invention that the sequence may be varied. Various permutations of the algorithm are contemplated as alternate embodiments of the invention.

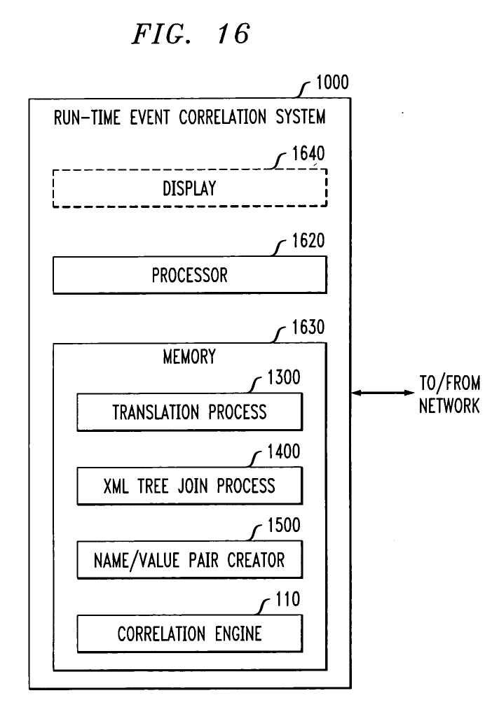

FIG. 16 is a block diagram of a Run-Time Event Correlation system 1600 that can implement the processes of the present invention. As shown in FIG. 16, memory 1630 configures the processor 1620 to implement processes 1300, 1400, 1500, and 110. The memory 1630 could be distributed or local and the processor 1620 could be distributed or singular. The memory 1630 could be implemented as an electrical, magnetic or optical memory, or any combination of these or other types of storage devices. It should be noted that each distributed processor that makes up processor 1620 generally contains its own addressable memory space. It should also be noted that some or all of computer system 1600 can be incorporated into an application-specific or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for correlating structured event data, comprising the steps of:
selecting one or more aggregation elements; and
creating a structured template utilizing said one or more selected aggregation elements.

2. The method of claim 1, further comprising the step of translating said structured event data to name-value pair sets based on said structured template.

3. The method of claim 1, wherein said structured template is created by searching said structured event data for repeatable node-value pairs.

4. The method of claim 1, further comprising the step of creating a region tree, wherein intermediate nodes represent shared fragments, leaf nodes represent regions, and wherein regions are a unique set of nodes whose sub-tree can have multiple occurrences.

5. The method of claim 1, wherein the content of repeatable elements not selected as aggregation elements is ignored.

6. The method of claim 1, wherein the content of repeatable elements not selected as aggregation elements is concatenated into a value string.

7. The method of claim 1, wherein said selection step is performed by a user.

8. A method for translating structured event data, comprising the steps of:
obtaining a structured template; and
translating said structured event data to name-value pair sets based on said structured template.

9. The method of claim 8, further comprising the steps of:
parsing said structured event data in depth first search order; and
forming regions based on an aggregation element set.

10. The method of claim 8, further comprising the steps of:
obtaining a region tree;
selecting one instance from each region; and
joining said selected instances to form a target that conforms to a translation rule syntax.

11. The method of claim 8, wherein said steps are repeated until all combinations of instances are created.

12. The method of claim 10, wherein said target is in name-value form.

13. The method of claim 8, wherein a same name in an event instance is resolved using special characters.

14. The method of claim 8, wherein said structured event translation method joins region instances from different regions to form event instances.

15. A method to generate event translation style sheets based on one or more region trees, comprising the steps of:
parsing said one or more region trees;
forming a filtering script that conforms to a style sheet grammar, wherein said forming step is performed for each aggregation node in said one or more region trees; and
collecting said filtering script for event translation.

16. A method to generate rule sessions based on one or more region trees, comprising the steps of:
parsing said one or more region trees;
forming a partial rule template that conforms to a rule grammar, wherein said forming step is performed for every aggregation node in said one or more region trees; and
collecting said partial rule template for event translation.

17. A method to generate a region tree, comprising the steps of:
selecting a node from an aggregation set;
traversing each branch of an event schema graph in a depth first search order, wherein said traversal on a branch is halted whenever a selection aggregation element is encountered; and
adding a new region node to said region tree to represent visited nodes.

18. The method of claim 17, further comprising the step of connecting a new region node to one or more existing region nodes if one or more corresponding schema nodes are connected.

19. An apparatus for correlating structured event data, comprising:
a memory; and
at least one processor, coupled to the memory, operative to:
select one or more aggregation elements; and
create a structured template utilizing said one or more selected aggregation elements.

20. The apparatus of claim 19, wherein said apparatus is configured to translate structured event data by:
obtaining a structured template; and
translating said structured event data to name-value pair sets based on said structured template.
